(19) United States
(12) Patent Application Publication
(10) Pub. No.: US 2026/0105668 A1
(43) Pub. Date: Apr. 16, 2026

(54) METHOD FOR GENERATING ANIMATION FILES AND PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventor: YUNFEI SI, Jiangsu (CN)

(21) Appl. No.: 19/250,424

(22) Filed: Jun. 26, 2025

(30) Foreign Application Priority Data
Oct. 10, 2024 (CN) 202411416096X

(51) Int. Cl. G06T 13/00; G06Q 30/0241

(52) U.S. Cl. CPC G06T 13/00; G06Q 30/0276

(57) ABSTRACT

An animation file generation method includes obtaining an animation design file, determining keyframe animation information corresponding to each keyframe based on the animation design file, determining an attribute change trajectory of layer animation attributes corresponding to each layer in the animation design file based on layer animation information corresponding to each layer and the keyframe animation information corresponding to each keyframe in the animation design file, performing keyframe reduction on each layer based on the attribute change trajectory of the layer animation attributes corresponding to each layer to obtain a set of target keyframes corresponding to each layer, and generating a target animation file based on the set of target keyframes corresponding to each layer. It enables efficient and convenient generation of animation files, shortens the animation development cycle, improves the playback performance of animation files, thereby facilitating the creation of advertisement pages, and enhancing customer acquisition efficiency.

### CROSS REFERENCE TO RELATED APPLICATIONS AND CLAIM OF PRIORITY

This application claims the benefit under 35 USC § 119 of Chinese Patent Application No. 202411416096X filed on Oct. 10, 2024, in the Chinese Intellectual Property Office, the entire disclosure of which is incorporated herein by reference for all purposes.

### BACKGROUND

### 1. Technical Field

The present application generally relates to the technical field of data processing. More specifically, the present application relates to an animation file generation method and related products.

### 2. Background Art

With the increasing popularity of mobile devices and the growing volume of advertisement placements, people can now view various types of advertisements anytime and anywhere. To attract customers more effectively and encourage them to participate in promotional activities through advertisement information, increasingly rich animation effects are needed to modify advertisements. Traditional animation development methods involve designers completing page design and animation design of advertisement pages, followed by communication with webpage developers to explain the animation videos and reach a consensus, and finally, the webpage developers manually restoring the animations frame by frame. This approach results in a lengthy development process, requiring constant confirmation of details between webpage developers and designers, and errors are prone to occur during the process, leading to animation effects that do not meet expectations.

In view of this, there is an urgent need to provide an animation file generation method that can efficiently and conveniently generate animation files, shorten the animation development cycle, improve the playback performance of animation files, thereby facilitating the generation of advertisement pages, and enhancing customer acquisition efficiency.

### SUMMARY

To at least address one of the technical problems mentioned above, the present application proposes an animation file generation method and related products in various aspects.

In a first aspect, the present application provides an animation file generation method, including: obtaining an animation design file; determining keyframe animation information corresponding to each keyframe based on the animation design file; determining an attribute change trajectory of layer animation attributes corresponding to each layer in the animation design file based on layer animation information corresponding to each layer and the keyframe animation information corresponding to each keyframe in the animation design file; performing keyframe reduction on each layer based on the attribute change trajectory of the layer animation attributes corresponding to each layer to obtain a set of target keyframes corresponding to each layer; and generating a target animation file based on the set of target keyframes corresponding to each layer.

In some embodiments, the determining keyframe animation information corresponding to each keyframe based on the animation design file includes: performing basic style parsing on each layer in the animation design file to obtain basic layer information corresponding to each layer; performing parsing based on the basic layer information corresponding to each layer to obtain layer animation information corresponding to each layer; determining keyframes corresponding to each layer based on the layer animation information corresponding to each layer; and determining keyframe animation information corresponding to each keyframe based on the layer animation information corresponding to each layer and position information of the keyframes corresponding to each layer.

In some embodiments, the basic layer information includes a layer type; wherein the parsing layer animation information corresponding to each layer based on the basic layer information corresponding to each layer includes: performing parsing based on the layer type corresponding to each layer to obtain layer animation information corresponding to each layer.

In some embodiments, the determining keyframes corresponding to each layer based on the layer animation information corresponding to each layer includes: determining keyframes corresponding to each layer based on a property attribute of each animation frame in the layer animation information corresponding to each layer.

In some embodiments, the determining keyframe animation information corresponding to each keyframe based on the layer animation information corresponding to each layer and the position information of the keyframes corresponding to each layer includes: determining whether a keyframe exists after each animation frame of each layer based on the position information of the keyframe corresponding to each layer; if a keyframe corresponding to the current layer exist after the current animation frame, moving layer animation information corresponding to the current animation frame to the keyframe corresponding to the current layer; and if no keyframe corresponding to the current layer exists after the current animation frame, determining layer animation information corresponding to each animation frame stored in the keyframe corresponding to the current layer as the keyframe animation information of the keyframe corresponding to the current layer.

In some embodiments, the determining the attribute change trajectory of layer animation attributes for each layer in the animation design file based on the layer animation information corresponding to each layer and the keyframe animation information corresponding to each keyframe includes: storing attribute change records of layer animation attributes in the layer animation information corresponding to each layer that match the keyframe animation information corresponding to the keyframes of the respective layer; storing the attribute change relationships between each attribute change node in each attribute change record and the animation attributes of the corresponding keyframe animation information; and determining an attribute change trajectory of the layer animation attributes corresponding to each layer based on each attribute change record and each attribute change relationship.

In some embodiments, the performing keyframe reduction on each layer based on the attribute change trajectory of the layer animation attributes corresponding to each layer includes: determining an animation curvature curve corresponding to each layer based on a preset vector curve and the attribute change trajectory of the layer animation attributes corresponding to each layer; and performing keyframe reduction on each layer based on the animation curvature curve corresponding to each layer.

In some embodiments, the performing keyframe reduction on each layer based on the animation curvature curve corresponding to each layer includes: deleting N consecutive keyframes with the same curvature and the same animation attributes based on the animation curvature curve, wherein N is an integer greater than 2; and merging keyframes with the same time point but different animation attributes based on the animation curvature curve.

In some embodiments, before generating the target animation file based on the set target keyframes corresponding to each layer, the method further includes: obtaining animation configuration information; and determining loop playback count and playback frequency of the target animation file based on the animation configuration information.

In a second aspect, the present application provides a device for animation file generation, including: a memory; and at least one processor configured to: obtain an animation design file; determine keyframe animation information corresponding to each keyframe based on the animation design file; determine an attribute change trajectory of layer animation attributes for each layer in the animation design file based on layer animation information corresponding to each layer and the keyframe animation information corresponding to each keyframe; perform keyframe reduction on each layer based on the attribute change trajectory of the layer animation attributes corresponding to each layer to obtain a set of target keyframes corresponding to each layer; and generate a target animation file based on the set of target keyframes corresponding to each layer.

In a third aspect, the present application provides a non-transitory machine-readable medium storing program code thereon for animation file generation, wherein when the program code is executed by at least one processor, the code directs the at least one processor to perform operations including: obtaining an animation design file; determining keyframe animation information corresponding to each keyframe based on the animation design file; determining an attribute change trajectory of layer animation attributes for each layer in the animation design file based on layer animation information corresponding to each layer and the keyframe animation information corresponding to each keyframe; performing keyframe reduction on each layer based on the attribute change trajectory of the layer animation attributes corresponding to each layer to obtain a set of target keyframes corresponding to each layer; and generating a target animation file based on the set of target keyframes corresponding to each layer.

The technical solutions provided by the present application may include the following favorable effects:

The animation file generation method and related products provided by the present application obtain an animation design file, determine keyframe animation information corresponding to each keyframe based on the animation design file, and further determine an attribute change trajectory of layer animation attributes corresponding to each layer in the animation design file based on the layer animation information corresponding to each layer and the keyframe animation information corresponding to each keyframe. This allows direct processing of the designed animation design file to confirm the attribute change trajectory of the layer animation attributes for each layer, avoiding cumbersome communication between designers and webpage developers and solving the problem of animation production errors caused by misunderstandings during the communication. This helps to reduce the workload for designers and webpage developers and shortens the animation development cycle.

Furthermore, the present application can perform keyframe reduction on each layer based on the attribute change trajectory of the layer animation attributes corresponding to each layer to obtain a set of target keyframes corresponding to each layer, and then generate a target animation file based on the set of target keyframes corresponding to each layer. This reduces the file volume of the target animation file, improves the playback performance of the animation file, and facilitates the generation of advertisement pages.

In summary, the present application enables efficient and convenient generation of animation files, shortens the animation development cycle, improves the playback performance of animation files, facilitates the generation of advertisement pages, and enhances customer acquisition efficiency.

### BRIEF DESCRIPTION OF THE DRAWINGS

By referring to the detailed description of the embodiments below in conjunction with the accompanying drawings, the above and other objectives, features, and advantages of the exemplary embodiments of the present application will become more apparent. In the drawings, several embodiments of the present application are shown in an illustrative rather than restrictive manner, and the same or corresponding reference numerals denote the same or corresponding parts.

FIG. 1 shows an exemplary flowchart of an animation file generation method according to some embodiments of the present application;

FIG. 2 shows an exemplary flowchart of an animation file generation method according to other embodiments of the present application;

FIG. 3 shows an exemplary flowchart of an animation file generation method according to further embodiments of the present application; and

FIG. 4 shows a block diagram of hardware configuration of a device 400 for animation file generation that can implement the animation file generation method according to the embodiments of the present application.

### DETAILED DESCRIPTION

The technical solutions in the embodiments of the present application will be described clearly and completely below with reference to the accompanying drawings. It is apparent that the described embodiments are only a part rather than all of the embodiments of the present application. For simplicity and clarity, respective reference numerals may be repeated in the drawings to indicate corresponding or similar elements. Additionally, many details are set forth in the present application to provide a thorough understanding on the described embodiments. However, those skilled in the art will understand that the embodiments described herein can be practiced without these details. In other instances, well-known methods, procedures, and components have not been described in detail to avoid obscuring the described embodiments. Moreover, the description should not be construed as limiting the scope of the embodiments described herein. Based on the embodiments of the present application, all other embodiments obtained by those skilled in the art without creative effort shall fall within the protection scope of the present application.

It should be understood that terms such as “first” or “second” that may be used in the claims, description, and drawings revealed in the present application are intended to distinguish between different objects and not to describe a specific order. The terms “comprising” and “including” used in the description and claims of the present application indicate the presence of the described features, entities, steps, operations, elements, and/or components, but do not exclude the presence or addition of one or more other features, entities, steps, operations, elements, components, and/or combinations thereof.

It should also be understood that the terminology used herein is for the purpose of describing specific embodiments only and is not intended to limit the present application. As used in the description and claims of the present application, the singular forms “a,” “an,” and “the” are intended to include the plural forms unless the context clearly indicates otherwise. It should also be further understood that the term “and/or” used in the description and claims of the present application refers to and includes any and all possible combinations of one or more of the associated listed items.

As used in the description and claims, the term “if” may be interpreted contextually as “when,” “once,” “in response to determining,” or “in response to detecting.” Similarly, the phrase “if it is determined” or “if [a described condition or event] is detected” may be interpreted contextually as meaning “once it is determined,” “in response to determining,” “once [the described condition or event] is detected,” or “in response to detecting [the described condition or event].”

Traditional animation development methods involve related designers completing page design and animation design of advertisement pages, followed by communication with webpage developers to explain the animation videos and reach a consensus, and finally, the webpage developers manually restoring the animations frame by frame. This approach results in a lengthy development process, requiring constant confirmation of details between webpage developers and designers, and errors are prone to occur during the process, leading to animation effects that do not meet expectations.

In view of this, there is an urgent need to provide an animation file generation method that can efficiently and conveniently generate animation files, shorten the animation development cycle, improve the playback performance of animation files, thereby facilitating the generation of advertisement pages, and enhancing customer acquisition efficiency.

The embodiments of the present application will now be described in detail below with reference to the accompanying drawings.

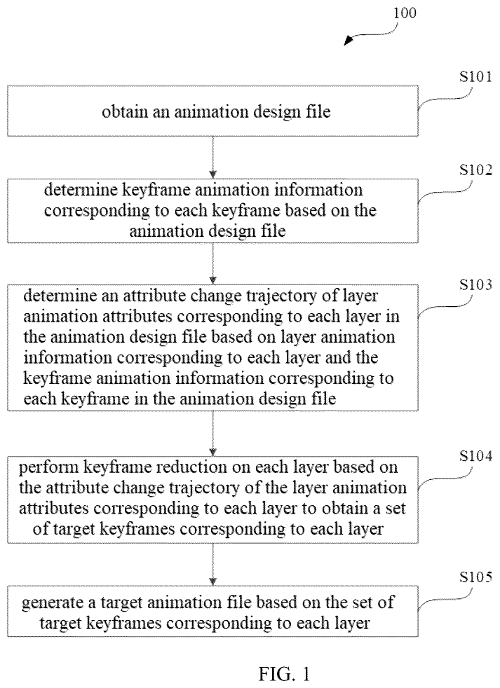

FIG. 1 shows an exemplary flowchart 100 of an animation file generation method according to some embodiments of this application. Referring to FIG. 1, the animation file generation method shown in the embodiments of this application may include the following steps:

In step S101, an animation design file is acquired. In the embodiments of this application, the animation design file refers to a design file created by designers using animation design software, such as Adobe After Effects. In practical applications, suitable animation design software should be selected based on actual application conditions, and this application imposes no limitations in this regard.

In step S102, keyframe animation information corresponding to each keyframe is determined based on the animation design file. In the embodiments of this application, the animation design file can be processed directly in the animation design software, allowing the desired target animation file to be directly derived from the animation design software. To determine the keyframe animation information corresponding to each keyframe, keyframes can first be determined from the animation design file, and then the keyframe animation information corresponding to the keyframes can be obtained. The keyframe animation information may include, but is not limited to, element displacement information, element rotation angle change information, element transparency change information, and element shape size change information.

In step S103, an attribute change trajectory of layer animation attributes corresponding to each layer in the animation design file is determined based on layer animation information corresponding to each layer in the animation design file and keyframe animation information corresponding to each keyframe. It is understandable that an animation design file may contain multiple layers, each of which may include one or more elements. The animation information of these one or more elements constitutes the layer animation information. Based on the layer animation information, changes in the animation attributes of each element can be learnt. Based on all these animation attribute changes and keyframe animation information corresponding to each keyframe, a relationship between each animation attribute change and the keyframes can be determined, thereby determining an attribute change trajectory of the layer animation attributes corresponding to each layer. The layer animation attributes may include animation attributes of each element in the layer, such as element displacement, element rotation angle, element transparency, and element shape size. In other words, the attribute change trajectory of the layer animation attributes corresponding to the current layer may include a change trajectory of each animation attribute of each element in the layer animation attributes of the current layer.

In step S104, keyframe reduction is performed on each layer based on the attribute change trajectory of the layer animation attributes corresponding to each layer to obtain a set of target keyframes corresponding to each layer. In the embodiments of this application, methods for keyframe reduction include, but are not limited to, merging and deletion. In practical applications, suitable keyframe reduction methods should be selected based on actual application conditions, and this application imposes no limitations in this regard. The purpose of keyframe reduction is to reduce the file volume of the target animation file, thereby improving animation playback performance.

In step S105, a target animation file is generated based on the set of target keyframes corresponding to each layer. In the embodiments of this application, the target animation file as mentioned above may be of an animation file of the webview animation file type. It is understandable that in practical applications, the file type of the target animation file should be determined based on actual application conditions, and the target animation file is then generated based on the desired file type. This application imposes no limitations in this regard.

The embodiments of this application acquire an animation design file, determine keyframe animation information corresponding to each keyframe based on the animation design file, and then determine an attribute change trajectory of layer animation attributes corresponding to each layer in the animation design file based on the layer animation information corresponding to each layer in the animation design file and the keyframe animation information corresponding to each keyframe. This allows direct processing of the designed animation design file to confirm the attribute change trajectory of each layer's animation attributes, avoiding cumbersome communication between designers and webpage developers and solving the problem of animation production errors caused by misunderstandings during the communication, thereby reducing the workload of designers and webpage developers and shortening the animation development cycle. Furthermore, this application performs keyframe reduction on each layer based on the attribute change trajectory of the layer animation attributes corresponding to each layer to obtain a set of target keyframes corresponding to each layer, and then generates a target animation file based on the set of target keyframes corresponding to each layer, thereby reducing the file volume of the target animation file and improving the playback performance of the animation file, which facilitates the generation of advertisement pages.

In summary, this application can efficiently and conveniently generate animation files, shorten the animation development cycle, improve the playback performance of animation files, thereby facilitating the generation of advertisement pages and enhancing customer acquisition efficiency.

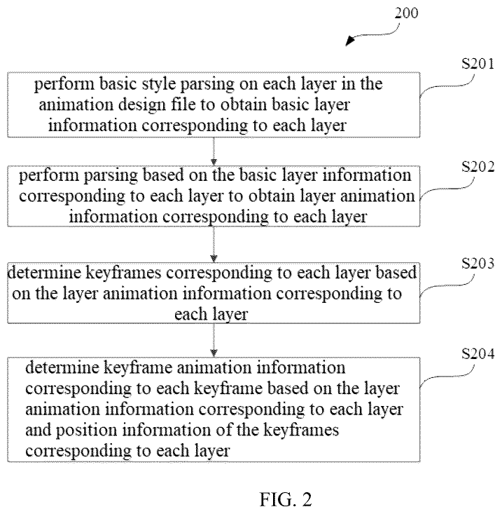

In some embodiments, keyframes can first be determined from the animation design file, and then keyframe animation information corresponding to the keyframes can be obtained. The process of determining the keyframe animation information is described in detail below with reference to FIG. 2. FIG. 2 shows an exemplary flowchart 200 of an animation file generation method according to some other embodiments of this application. Referring to FIG. 2, the animation file generation method shown in the embodiments of this application may include the following steps:

In step S201, basic style parsing is performed on each layer in the animation design file to obtain layer basic information corresponding to each layer. In the embodiments of this application, the basic style parsing primarily involves analyzing layer order, layer transparency, layer type, layer transformations (rotation, scaling, tilting), layer positioning, and layer dimensions. Thus, the obtained layer basic information may include, but is not limited to, layer type, layer transparency, layer rotation angle, layer positioning coordinates, and layer dimension information.

In step S202, layer basic information corresponding to each layer is parsed to obtain layer animation information corresponding to each layer. In the embodiments of this application, the layer animation information corresponding to each layer can be obtained by parsing the layer type corresponding to each layer. For example, it is supposed the animation design file is created using the animation design software Adobe After Effects. Thus, the animation design file derived from Adobe After Effects contains the attribute app. project. activeItem. layers corresponding to each animation frame in each layer, in which layer type corresponding to each animation frame and animation information matching the layer type is recorded. For instance, when the layer type is a text layer, the animation information matching the text layer may include, but is not limited to, text content, and the animation information matching the image layer may include, but is not limited to, png-format image materials. Therefore, based on the layer type corresponding to each layer obtained from basic style parsing, the animation information corresponding to each animation frame in each layer can be parsed and retrieved, thereby obtaining layer animation information corresponding to each layer.

It is understandable that different pieces of animation design software use different attributes to record the layer type corresponding to each animation frame and the animation information matching the layer type. In practical applications, the attribute used to obtain the layer type corresponding to each animation frame and the animation information matching the layer type should be determined based on the practically selected animation design software, and this attribute is thus used to parse and determine the layer animation information corresponding to each layer. This application imposes no limitations in this regard.

In step S203, keyframes corresponding to each layer are determined based on layer animation information corresponding to each layer. In the embodiments of this application, the keyframes corresponding to each layer can be determined based on the property attribute of each animation frame in the layer animation information corresponding to each layer. Continuing with the example in step S202, the attribute app.project.activeItem.layers also includes fields that can determine whether each animation frame is a keyframe. For example, the field may be app.project.activeItem.layers[x].property(key).keyTime(index). Here, the property(key) in the field indicates that the current animation frame is a keyframe, and the keyTime(index) records the time of the current animation frame.

It is understandable that different pieces of animation design software use different attributes of field to record whether each animation frame is a keyframe. In practical applications, the attributes of field used to determine whether each animation frame is a keyframe should be determined based on the practically selected animation design software, and this attribute is thus used to determine the keyframes corresponding to each layer. This application imposes no limitations in this regard.

In step S204, keyframe animation information corresponding to each keyframe is determined based on the layer animation information corresponding to each layer and the position information of the keyframes corresponding to each layer. In the embodiments of this application, it can first be determined whether a keyframe exists after each animation frame of each layer based on the position information of the keyframes corresponding to each layer. If a keyframe corresponding to the current layer exists after the current animation frame, the layer animation information corresponding to the current animation frame is moved to the keyframe corresponding to the current layer. It should be noted that there may be one or more keyframes corresponding to the current layer, but the keyframe corresponding to the current layer that exists after the current animation frame refers to a keyframe closest to the current animation frame and located after it. Additionally, if no keyframe corresponding to the current layer exists after the current animation frame, the layer animation information corresponding to each animation frame stored in the keyframe corresponding to the current layer is determined as the keyframe animation information of the keyframe corresponding to the current layer.

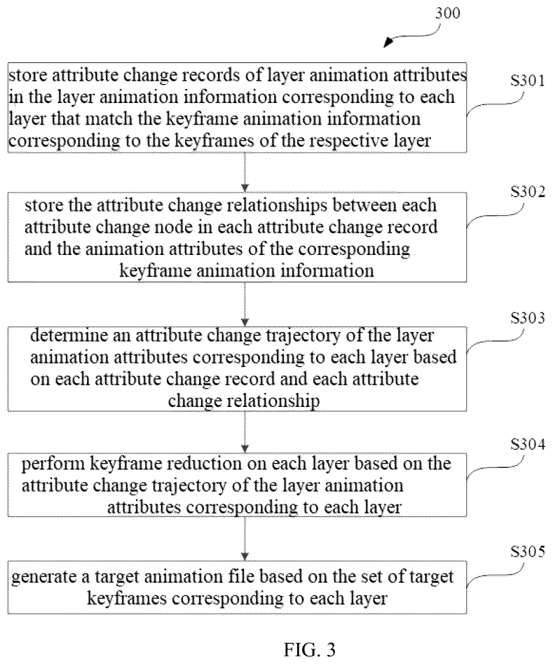

In some embodiments, the attribute change trajectory needs to be reduced to decrease the file volume of the target animation file. The process of determining the attribute change trajectory and the process of reducing the attribute change trajectory are described in detail below with reference to FIG. 3. FIG. 3 shows an exemplary flowchart 300 of an animation file generation method according to further embodiments of this application. Referring to FIG. 3, the animation file generation method shown in the embodiments of this application may include the following steps:

In step S301, attribute change records of the layer animation attributes in the layer animation information corresponding to each layer that match the keyframe animation information corresponding to the keyframes of the respective layers. In the embodiments of this application, layer animation attributes consistent with keyframe animation information corresponding to keyframes of respective layers can be found out from layer animation information corresponding to each layer, and attribute change records of these consistent layer animation attributes can be stored. Examples of the attribute change records include layer transparency change records, layer rotation angle change records, layer positioning coordinate change records, and layer dimension change records.

In step S302, an attribute change relationship between each attribute change node in each attribute change record and animation attributes of the corresponding keyframe animation information is stored. In the embodiments of this application, the relationship between each change (i.e., each attribute change node) in each attribute change record and the animation attributes of the corresponding keyframe animation information can be determined. For example, a conversion relationship between a current layer transparency change node and a keyframe layer transparency of the corresponding keyframe animation information is determined. After confirmation, all attribute change relationships are stored.

In step S303, an attribute change trajectory of layer animation attributes corresponding to each layer is determined based on each attribute change record and each attribute change relationship. It is understandable that based on each attribute change record and each attribute change relationship, the change trajectory of each animation attribute of each animation frame in each layer can be determined, and these change trajectories constitute the aforementioned attribute change trajectory. This ensures that the keyframes can restore the animation of each animation frame in the layer based on the corresponding keyframe animation information and the change trajectory of each animation attribute.

In step S304, keyframe reduction is performed on each layer based on the attribute change trajectory of the layer animation attributes corresponding to each layer. In the embodiments of this application, an animation curvature curve corresponding to each layer can first be determined based on a preset vector curve and the attribute change trajectory of the layer animation attributes corresponding to each layer. Here, the preset vector curve may be a Bézier curve, and the animation curvature curve corresponding to each layer can be determined based on the curvature of the Bézier curve and the attribute change trajectory of the layer animation attributes corresponding to each layer. It is understandable that the specific form of the preset vector curve is diverse. In practical applications, the specific form of the preset vector curve should be determined based on actual application conditions, and this application imposes no limitations in this regard.

Further, keyframe reduction can be performed on each layer based on the animation curvature curve corresponding to each layer. Specifically, consecutive N keyframes with the same curvature and the same animation attributes can be deleted based on the animation curvature curve, where N is an integer greater than 2. Preferably, N may be set to 3. In practical applications, the value of N should be determined based on actual application conditions, and this application imposes no limitations in this regard. Simultaneously, keyframes with the same time point but different animation attributes can be merged based on the animation curvature curve.

In step S305, a target animation file is generated based on a set of target keyframes corresponding to each layer. In the embodiments of this application, before generating the target animation file, animation configuration information needs to be acquired. The animation configuration information may include, but is not limited to, playback count, playback frequency, and animation file type. Subsequently, loop playback count and playback frequency of the target animation file can be determined based on the animation configuration information, and finally, a target animation file conforming to the desired animation file type can be generated based on the set of target keyframes corresponding to each layer. The animation file type will be played according to the loop playback count and playback frequency.

Corresponding to the aforementioned embodiments in which methods are carried out by applying functions, this application also provides a device for animation file generation and corresponding embodiments.

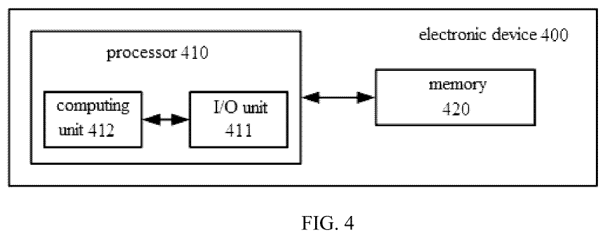

FIG. 4 shows a block diagram of a hardware configuration of a device 400 for animation file generation that can implement the animation file generation method according to the embodiments of this application. As shown in FIG. 4, the device 400 for animation file generation may include a processor 410 and a memory 420. In the device 400 for animation file generation shown in FIG. 4, only the components relevant to this embodiment are illustrated. Therefore, it will be apparent to those skilled in the art that the device 400 for animation file generation may also include other common components different from those shown in FIG. 4, such as a fixed-point arithmetic unit.

The device 400 for animation file generation may correspond to a computing device with various processing functions, such as functions of generating neural networks, training or learning neural networks, quantizing floating-point neural networks into fixed-point neural networks, or retraining neural networks. For example, the device 400 for animation file generation may be implemented as various types of devices, such as personal computers (PCs), server devices, mobile devices, etc.

The processor 410 controls all functions of the device 400 for animation file generation. For example, the processor 410 controls all functions of the device 400 for animation file generation by executing programs stored in the memory 420 on the device 400 for animation file generation. The processor 410 may be implemented by a central processing unit (CPU), a graphics processing unit (GPU), an application processor (AP), an artificial intelligence processor chip (IPU), etc., provided in the device 400 for animation file generation. However, this application is not limited thereto.

In some embodiments, the processor 410 may include an input/output (I/O) unit 411 and a computing unit 412. The I/O unit 411 may be used to receive various data, such as an animation design file. For example, the computing unit 412 may be used to determine keyframe animation information corresponding to each keyframe based on the animation design file received via the I/O unit 411; determine an attribute change trajectory of layer animation attributes corresponding to each layer in the animation design file based on the layer animation information corresponding to each layer in the animation design file and keyframe animation information corresponding to each keyframe; perform keyframe reduction on each layer based on the attribute change trajectory of the layer animation attributes corresponding to each layer to obtain a set of target keyframes corresponding to each layer; and generate a target animation file based on the set of target keyframes corresponding to each layer. This target animation file may, for example, be outputted by the I/O unit 411. The output data may be provided to the memory 420 for use by other devices (not shown) or directly provided to other devices for use.

The memory 420 is hardware for storing various data processed in the device 400 for animation file generation. For example, the memory 420 may store processed data and data to be processed in the device 400 for animation file generation. The memory 420 may store datasets involved in the animation file generation method processed or to be processed by the device 400 for animation file generation, such as animation design files. Additionally, the memory 420 may store applications, drivers, etc., to be driven by the device 400 for animation file generation. For example, the memory 420 may store various programs related to the animation file generation method to be executed by the processor 410. The memory 420 may be DRAM, but this application is not limited thereto. The memory 420 may include at least one of a volatile memory or a non-volatile memory. The non-volatile memory may include read-only memory (ROM), programmable ROM (PROM), electrically programmable ROM (EPROM), electrically erasable programmable ROM (EEPROM), flash memory, phase-change RAM (PRAM), magnetic RAM (MRAM), resistive RAM (RRAM), ferroelectric RAM (FRAM), etc. The volatile memory may include dynamic RAM (DRAM), static RAM (SRAM), synchronous DRAM (SDRAM), PRAM, MRAM, RRAM, ferroelectric RAM (FeRAM), etc. In embodiments, the memory 420 may include at least one of a hard disk drive (HDD), a solid-state drive (SSD), compact flash (CF), a secure digital (SD) card, a micro-SD card, a mini-SD card, an extreme digital (xD) card, caches, or a memory stick.

In summary, the specific functions implemented by the memory 420 and the processor 410 of the device 400 for animation file generation provided in the embodiments of this specification can be explained in conjunction with the foregoing embodiments of this specification and achieve the technical effects of the foregoing embodiments. Therefore, they will not be repeated here.

It should also be understood that any module, unit, component, server, computer, terminal, or device that executes instructions as exemplified herein may include or otherwise access a computer-readable medium, such as a storage medium, computer storage medium, or data storage device (removable and/or non-removable), such as a magnetic disk, optical disk, or tape. Computer storage media may include volatile and non-volatile, removable and non-removable media implemented in any method or technology for storing information, such as computer-readable instructions, data structures, program modules, or other data.

The foregoing content can be better understood in accordance with the following clauses:
Clause A1. An animation file generation method, including: obtaining an animation design file; determining keyframe animation information corresponding to each keyframe based on the animation design file; determining an attribute change trajectory of layer animation attributes corresponding to each layer in the animation design file based on layer animation information corresponding to each layer and the keyframe animation information corresponding to each keyframe in the animation design file; performing keyframe reduction on each layer based on the attribute change trajectory of the layer animation attributes corresponding to each layer to obtain a set of target keyframes corresponding to each layer; and generating a target animation file based on the set of target keyframes corresponding to each layer.
Clause A2. The animation file generation method according to Clause A1, wherein the determining keyframe animation information corresponding to each keyframe based on the animation design file includes: performing basic style parsing on each layer in the animation design file to obtain basic layer information corresponding to each layer; performing parsing based on the basic layer information corresponding to each layer to obtain layer animation information corresponding to each layer; determining keyframes corresponding to each layer based on the layer animation information corresponding to each layer; and determining keyframe animation information corresponding to each keyframe based on the layer animation information corresponding to each layer and position information of the keyframes corresponding to each layer.
Clause A3. The animation file generation method according to Clause A2, wherein the basic layer information includes a layer type; wherein the parsing layer animation information corresponding to each layer based on the basic layer information corresponding to each layer includes: performing parsing based on the layer type corresponding to each layer to obtain layer animation information corresponding to each layer.
Clause A4. The animation file generation method according to Clause A2, wherein the determining keyframes corresponding to each layer based on the layer animation information corresponding to each layer includes: determining keyframes corresponding to each layer based on a property attribute of each animation frame in the layer animation information corresponding to each layer.
Clause A5. The animation file generation method according to Clause A2, wherein the determining keyframe animation information corresponding to each keyframe based on the layer animation information corresponding to each layer and the position information of the keyframes corresponding to each layer includes: determining whether a keyframe exists after each animation frame of each layer based on the position information of the keyframe corresponding to each layer; if a keyframe corresponding to the current layer exist after the current animation frame, moving layer animation information corresponding to the current animation frame to the keyframe corresponding to the current layer; and if no keyframe corresponding to the current layer exists after the current animation frame, determining layer animation information corresponding to each animation frame stored in the keyframe corresponding to the current layer as the keyframe animation information of the keyframe corresponding to the current layer.
Clause A6. The animation file generation method according to Clause A1, wherein the determining the attribute change trajectory of layer animation attributes for each layer in the animation design file based on the layer animation information corresponding to each layer and the keyframe animation information corresponding to each keyframe includes: storing attribute change records of layer animation attributes in the layer animation information corresponding to each layer that match the keyframe animation information corresponding to the keyframes of the respective layer; storing the attribute change relationships between each attribute change node in each attribute change record and the animation attributes of the corresponding keyframe animation information; and determining an attribute change trajectory of the layer animation attributes corresponding to each layer based on each attribute change record and each attribute change relationship.
Clause A7. The animation file generation method according to Clause A1, wherein the performing keyframe reduction on each layer based on the attribute change trajectory of the layer animation attributes corresponding to each layer includes: determining an animation curvature curve corresponding to each layer based on a preset vector curve and the attribute change trajectory of the layer animation attributes corresponding to each layer; and performing keyframe reduction on each layer based on the animation curvature curve corresponding to each layer.
Clause A8. The animation file generation method according to Clause A7, wherein the performing keyframe reduction on each layer based on the animation curvature curve corresponding to each layer includes: deleting N consecutive keyframes with the same curvature and the same animation attributes based on the animation curvature curve, wherein N is an integer greater than 2; and merging keyframes with the same time point but different animation attributes based on the animation curvature curve.
Clause A9. The animation file generation method according to Clause A1, wherein before generating the target animation file based on the set target keyframes corresponding to each layer, the method further includes: obtaining animation configuration information; and determining loop playback count and playback frequency of the target animation file based on the animation configuration information.
Clause A10. A device for animation file generation, including: a memory; and at least one processor configured to: obtain an animation design file; determine keyframe animation information corresponding to each keyframe based on the animation design file; determine an attribute change trajectory of layer animation attributes for each layer in the animation design file based on layer animation information corresponding to each layer and the keyframe animation information corresponding to each keyframe; perform keyframe reduction on each layer based on the attribute change trajectory of the layer animation attributes corresponding to each layer to obtain a set of target keyframes corresponding to each layer; and generate a target animation file based on the set of target keyframes corresponding to each layer.
Clause A11. A non-transitory machine-readable medium storing program code thereon for animation file generation, wherein when the program code is executed by at least one processor, the code directs the at least one processor to perform operations including: obtaining an animation design file; determining keyframe animation information corresponding to each keyframe based on the animation design file; determining an attribute change trajectory of layer animation attributes for each layer in the animation design file based on layer animation information corresponding to each layer and the keyframe animation information corresponding to each keyframe; performing keyframe reduction on each layer based on the attribute change trajectory of the layer animation attributes corresponding to each layer to obtain a set of target keyframes corresponding to each layer; and generating a target animation file based on the set of target keyframes corresponding to each layer.

Although this text has illustrated and described a number of embodiments of the present application, it will be apparent to those skilled in the art that these embodiments are provided merely by way of example. Many modifications, changes, and alternatives may be conceived by those skilled in the art without departing from the spirits and scope of the present application. It should be understood that in the practice of the present application, various alternative solutions to the embodiments described herein may be employed. The appended claims are intended to define the scope of protection of the present application and thus cover equivalents or alternatives within the scope of these claims.

What is claimed is:

1. An animation file generation method comprising:
obtaining an animation design file;
determining keyframe animation information corresponding to each keyframe based on the animation design file;
determining an attribute change trajectory of layer animation attributes corresponding to each layer in the animation design file based on layer animation information corresponding to each layer and the keyframe animation information corresponding to each keyframe in the animation design file;
performing keyframe reduction on each layer based on the attribute change trajectory of the layer animation attributes corresponding to each layer to obtain a set of target keyframes corresponding to each layer; and
generating a target animation file based on the set of target keyframes corresponding to each layer.

2. The animation file generation method according to claim 1, wherein the determining keyframe animation information corresponding to each keyframe based on the animation design file comprises:
performing basic style parsing on each layer in the animation design file to obtain basic layer information corresponding to each layer;
performing parsing based on the basic layer information corresponding to each layer to obtain layer animation information corresponding to each layer;
determining keyframes corresponding to each layer based on the layer animation information corresponding to each layer; and
determining keyframe animation information corresponding to each keyframe based on the layer animation information corresponding to each layer and position information of the keyframes corresponding to each layer.

3. The animation file generation method according to claim 2, wherein the basic layer information includes a layer type; wherein the parsing layer animation information corresponding to each layer based on the basic layer information corresponding to each layer comprises:
performing parsing based on the layer type corresponding to each layer to obtain layer animation information corresponding to each layer.

4. The animation file generation method according to claim 2, wherein the determining keyframes corresponding to each layer based on the layer animation information corresponding to each layer comprises:
determining keyframes corresponding to each layer based on a property attribute of each animation frame in the layer animation information corresponding to each layer.

5. The animation file generation method according to claim 2, wherein the determining keyframe animation information corresponding to each keyframe based on the layer animation information corresponding to each layer and the position information of the keyframes corresponding to each layer comprises:
determining whether a keyframe exists after each animation frame of each layer based on the position information of the keyframe corresponding to each layer;
if a keyframe corresponding to the current layer exist after the current animation frame, moving layer animation information corresponding to the current animation frame to the keyframe corresponding to the current layer; and
if no keyframe corresponding to the current layer exists after the current animation frame, determining layer animation information corresponding to each animation frame stored in the keyframe corresponding to the current layer as the keyframe animation information of the keyframe corresponding to the current layer.

6. The animation file generation method according to claim 1, wherein the determining the attribute change trajectory of layer animation attributes for each layer in the animation design file based on the layer animation information corresponding to each layer and the keyframe animation information corresponding to each keyframe comprises:
storing attribute change records of layer animation attributes in the layer animation information corresponding to each layer that match the keyframe animation information corresponding to the keyframes of the respective layer;
storing the attribute change relationships between each attribute change node in each attribute change record and the animation attributes of the corresponding keyframe animation information; and
determining an attribute change trajectory of the layer animation attributes corresponding to each layer based on each attribute change record and each attribute change relationship.

7. The animation file generation method according to claim 1, wherein the performing keyframe reduction on each layer based on the attribute change trajectory of the layer animation attributes corresponding to each layer comprises:
determining an animation curvature curve corresponding to each layer based on a preset vector curve and the attribute change trajectory of the layer animation attributes corresponding to each layer; and
performing keyframe reduction on each layer based on the animation curvature curve corresponding to each layer.

8. The animation file generation method according to claim 7, wherein the performing keyframe reduction on each layer based on the animation curvature curve corresponding to each layer comprises:
deleting N consecutive keyframes with the same curvature and the same animation attributes based on the animation curvature curve, wherein N is an integer greater than 2; and
merging keyframes with the same time point but different animation attributes based on the animation curvature curve.

9. The animation file generation method according to claim 1, wherein before generating the target animation file based on the set target keyframes corresponding to each layer, the method further comprises:
obtaining animation configuration information; and
determining loop playback count and playback frequency of the target animation file based on the animation configuration information.

10. A device for animation file generation, the device comprising:
a memory; and
at least one processor configured to:
obtain an animation design file;
determine keyframe animation information corresponding to each keyframe based on the animation design file;
determine an attribute change trajectory of layer animation attributes for each layer in the animation design file based on layer animation information corresponding to each layer and the keyframe animation information corresponding to each keyframe;
perform keyframe reduction on each layer based on the attribute change trajectory of the layer animation attributes corresponding to each layer to obtain a set of target keyframes corresponding to each layer; and
generate a target animation file based on the set of target keyframes corresponding to each layer.

11. A non-transitory machine-readable medium storing program code thereon for animation file generation, wherein when the program code is executed by at least one processor, the code directs the at least one processor to perform operations comprising:
obtaining an animation design file;
determining keyframe animation information corresponding to each keyframe based on the animation design file;
determining an attribute change trajectory of layer animation attributes for each layer in the animation design file based on layer animation information corresponding to each layer and the keyframe animation information corresponding to each keyframe;
performing keyframe reduction on each layer based on the attribute change trajectory of the layer animation attributes corresponding to each layer to obtain a set of target keyframes corresponding to each layer; and
generating a target animation file based on the set of target keyframes corresponding to each layer.
